(19) United States
(12) Patent Application Publication
(10) Pub. No.: US 2020/0173788 A1
(43) Pub. Date: Jun. 4, 2020

(54) CORRECTING LOCATION INFORMATION USING MAP DATA

(71) Applicant: Alibaba Group Holding Limited, George Town (KY)

(72) Inventors: Xin Liu, Beijing (CN); Xinghao Wu, Beijing (CN); Jinfeng Liu, Shanghai (CN)

(21) Appl. No.: 16/784,690

(22) Filed: Feb. 7, 2020

Related U.S. Application Data
(63) Continuation-in-part of application No. PCT/CN2018/100748, filed on Aug. 16, 2018.

(30) Foreign Application Priority Data
Aug. 23, 2017 (CN) 201710731689.9

(51) Int. Cl. G01C 21/32; H04W 4/021; H04W 4/02; G06F 16/29

(52) U.S. Cl. CPC G01C 21/32; G06F 16/29; H04W 4/025; H04W 4/021

(57) ABSTRACT

Correction location information using map data is disclosed, including: obtaining detected location information associated with a system; obtaining context information associated with the system; determining matching road information using at least the detected location information and map data; determining the matching road information to be incorrect based at least in part on the context information; determining corrected location information based at least in part on the context information and the map data; and outputting the corrected location information.

### CROSS REFERENCE TO OTHER APPLICATIONS

This application is a continuation-in-part of and claims priority to International (PCT) Application No. PCT/CN18/100748 entitled POSITIONING METHOD AND APPARATUS, TERMINAL, SERVER, AND STORAGE MEDIUM, filed Aug. 16, 2018 which is incorporated herein by reference for all purposes, which claims priority to China Application No. 201710731689.9 entitled A POSITIONING METHOD, MEANS, TERMINAL, SERVER AND STORAGE MEDIUM, filed Aug. 23, 2017 which is incorporated herein by reference for all purposes.

### FIELD OF THE INVENTION

The present application relates to a field of computer technology. In particular, the present application relates to positioning information correction.

### BACKGROUND OF THE INVENTION

As the technology of smart phones develops, people have become more reliant on smart phones' service capabilities and information update speeds. To take phones' positioning features as an example, users generally prefer to use a positioning feature when walking, running, or driving.

However, the precision of positioning sensors of a device, such as a smart phone, is often negatively affected by environmental effects. For example, in an urban environment where there are obstacles, such as many tall buildings and elevated roads, satellite signals are subject to interference, which introduces errors in a device's determination of positioning information. Errors in positioning information that are caused by interference are sometimes referred to as “positional drift.”

### SUMMARY OF THE INVENTION

The present application discloses techniques comprising:

obtaining detected location information associated with the system; obtaining context information associated with the system; determining matching road information using at least the detected location information and map data; determining the matching road information to be incorrect based at least in part on the context information; determining corrected location information based at least in part on the context information and the map data; and outputting the corrected location information.

### BRIEF DESCRIPTION OF THE DRAWINGS

Various embodiments of the invention are disclosed in the following detailed description and the accompanying drawings.

FIG. 1 is a diagram showing an embodiment of a system for correcting positioning information.

FIG. 2 is a flow diagram showing an embodiment of a process for correcting location information associated with a device.

FIG. 3 is a flow diagram showing an example process for correcting location information associated with a device.

FIG. 4 is a flow diagram showing an example of a process for responding to a data request.

FIG. 5 is a flow diagram showing another example process for responding to a data request.

FIG. 6 is a diagram showing an embodiment of a diagram of a device-side positioning system.

FIG. 7 is a diagram showing an embodiment of a diagram of a server-side positioning system.

FIG. 8 is a hardware structural diagram of a computing device provided by some embodiments.

FIG. 9 is a hardware structural diagram of a computing device provided by some embodiments.

FIG. 10 is a diagram showing an example of a device operating system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of correcting location information using map data are described herein. Detected location information associated with a device is obtained. Context information associated with the device is obtained. Matching road information is determined using at least the detected location information and map data. The matching road information is determined to be incorrect based at least in part on the context information. Corrected location information is determined based at least in part on the context information and the map data. The corrected location information is outputted. For example, the corrected location information is used by an application to provide a location-based feature at a user interface. As will be described in further detail below, the detected location information that is generated by a location sensor of a device is matched to road information in map data. Whether the detected location information should be corrected is determined based on whether the matching road information is consistent with the context information. When the matching road information is inconsistent with the context information, it is then determined that the detected location information is to be corrected using at least the map data and the context information.

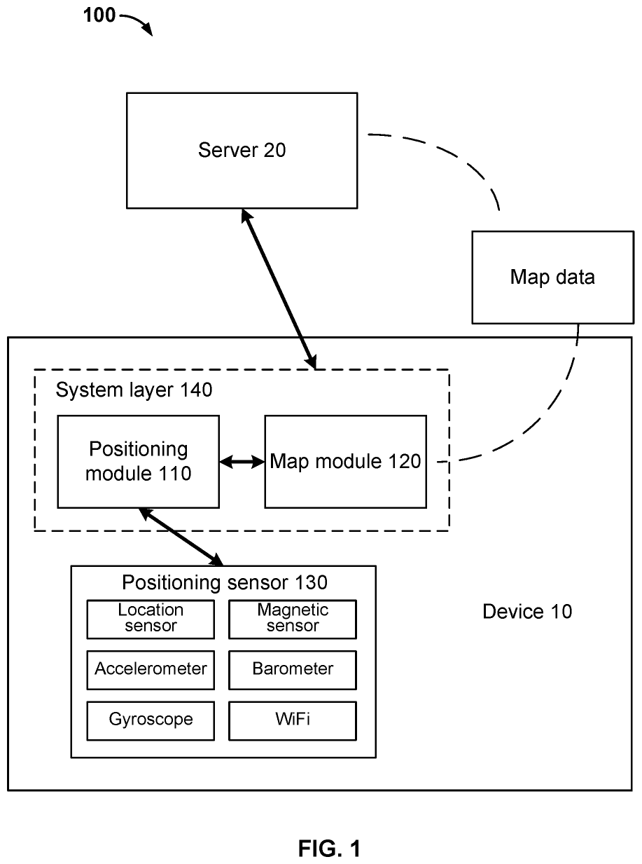

FIG. 1 is a diagram showing an embodiment of a system for correcting positioning information. System 100 includes server 20 and device 10. While not shown in FIG. 1, server 20 may communicate with device 10 over a data network and/or telecommunications network.

As shown in FIG. 1, device 10 includes a positioning function that is configured to determine positioning information with respect to device 10's location. For example, device 10 is any device that includes storage media and/or is configured to perform data processing. Examples of device 10 may be a mobile terminal or a smart wearable device. Device 10 includes positioning sensor 130, which may be a collection of one or more sensors that are configured to sense position/location metrics. In the example of FIG. 1, positioning sensor 130 is shown to include at least one of: a location sensor (a sensor that records longitudinal-latitudinal or other geographical coordinates), an accelerometer (an acceleration sensor), a gyroscope (e.g., an angular velocity sensor), a magnetic sensor (a sensor that measures magnetic fields and other parameters, e.g., the earth's magnetic field), a barometer (an air pressure sensor), and a WiFi receiver. In some embodiments, a location sensor includes a Global Navigation Satellite System (GNSS), which refers in general to all satellite navigation systems, including global, regional, and enhanced satellite navigation systems, such as the US's Global Positioning System (GPS), Russia's Glonass, Europe's Galileo, and China's BeiDou Navigation Satellite System. While not shown in FIG. 1, positioning sensor 130 may also include a Bluetooth receiver and other positioning sensors.

As shown in FIG. 1, device 10 includes system layer 140, which belongs to the operating system of device 10. System layer 140 includes positioning module 110 and map module 120. As will be described in detail further below, map data may already be stored in a storage media (e.g., memory) of device 10 or map module 120 may request map data from server 20. Also, as will be described in detail further below, road information that matches the detected location information that is generated by positioning sensor 130 may also be requested from server 20 by either positioning module 110 or map module 120.

In various embodiments, positioning module 110 of system layer 140 is configured to invoke positioning sensor 130 to obtain sensor data from one or more of its sensors. In various embodiments, sensor data obtained by positioning sensor 130 includes “detected location information” that is obtained via a location sensor. For example, the detected location information comprises a set of one or more geographical coordinates. In various embodiments, sensor data obtained by positioning sensor 130 also includes “context information” that is obtained via one or more sensors other than the location sensor. In some embodiments, the context information also includes data that is derived from the geographical coordinates that are sensed by the location sensor. For example, data that is derived from the geographical coordinates that are sensed by the location sensor may include the direction, speed, and the motion status of the device. In some embodiments, context information may also include other types of information that can be collected at device 10, such as, for example, from application(s) executing at device 10. In some embodiments, positioning module 110 is configured to invoke positioning sensor 130 to obtain sensor data in response to a request from an application executing at device 10 for positioning information.

When positioning module 110 is invoked at device 10, a user of device 10 is generally engaged in a moving activity, such as, for example, walking, running, or driving. For example, positioning module 110 is invoked by an application that is configured to track the user of device 10's movement as the user performs a moving activity such as walking, running, or driving. In tracking the user's movement, the detected location information obtained by positioning module 110 is compared to map data to identify matching road information. In various embodiments, “matching road information” comprises identifying information of one or more roads that match the geographical coordinate(s) of the detected location information. In some embodiments, one or more roads that match the geographical coordinate(s) of the detected location information include the road that the geographical coordinate(s) of the detected location information are directly on or one or more roads that are near the geographical coordinates of the detected location information. In some embodiments, positioning module 110 is configured to send map data and the detected location information to map module 120 for map module 120 to determine matching road information. In some embodiments, positioning module 110 is configured to send the detected location information to server 20 for server 20 to determine matching road information. In some embodiments, positioning module 110 is configured to obtain map data from server 20, store the map data locally, and then instruct map module 120 to determine matching road information using the detected location information and the locally stored map data.

After positioning module 110 receives the matching road information (e.g., from server 20 or map module 120), positioning module 110 determines whether the matching road information is incorrect based at least in part on the context information. For example, the context information indicates that the user of device 10 is driving because a driving route navigation application is currently executing at device 10. However, if the matching road information indicates that device 10 is not currently on a road and driving is expected to take place on a road, then the matching road information is determined to be incorrect. Furthermore, if the matching road information is determined to be incorrect, then it is implied that the detected location information was erroneous. As such, in response to a determination that the matching road information is incorrect, the detected location information is corrected to generate corrected location information.

After positioning module 110 determines that the matching road information is incorrect, positioning module 110 is configured to correct the detected location information based at least on the context information and the map data. In some embodiments, one or more candidate correction roads that are nearby the matching road information are determined from the map data. For example, the one or more candidate correction roads are roads that are in the matching road information that the detected location information was not directly on but were rather in the vicinity of the road on which the detected location information directly matched. Then, one such candidate correction road is selected using the context information. The corrected location information is determined based at least in part on the geographical coordinates associated with the selected candidate correction road and the context information. The corrected location information can then be used by an application executing at device 10. In some embodiments, the corrected location information is sent to the same application of the application layer that had requested the location information or to a different application. For example, the application may be a navigation application. In some embodiments, the corrected location information is sent to a different device to implement inter-device transmission of location information. For example, the corrected location information on a phone may be sent to a vehicle-mounted navigation device or a watch.

As will be described in further detail below, by using context information that is collected at device 10 and map data, it is possible to correct erroneous location information that is detected by device 10 to improve positioning accuracy and reduce location detection error.

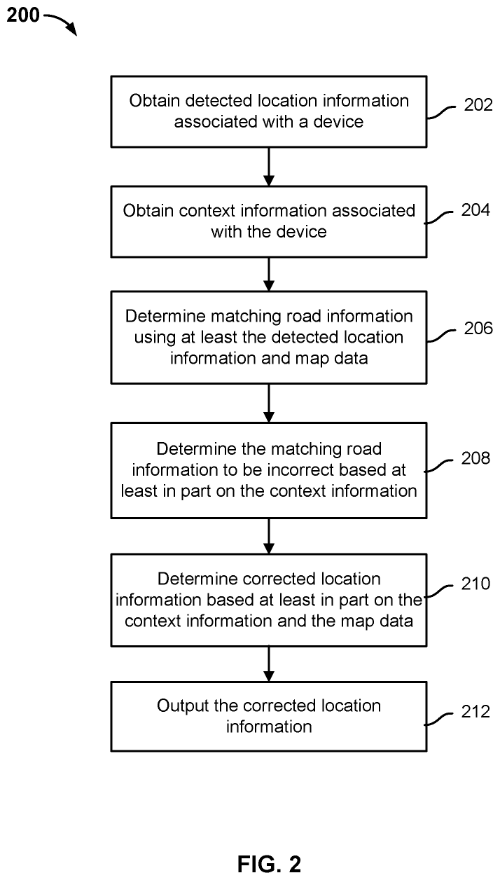

FIG. 2 is a flow diagram showing an embodiment of a process for correcting location information associated with a device. In some embodiments, process 200 is implemented at system 100 of FIG. 1. Specifically, in some embodiments, process 200 is implemented at device 10 of system 100 of FIG. 1.

Process 200 describes an embodiment of a process in which detected location information that is determined by a location sensor at a device is corrected using context information also collected at the device, as well as map data. For example, while the detected location information may not be sent to an application for providing a location-based feature, the corrected location information may be sent to an application for providing a location-based feature.

At 202, detected location information associated with a device is obtained. In various embodiments, the current location information of a device is obtained from a location sensor that is part of the device. For example, the location sensor is a GPS sensor that is able to obtain GPS coordinates from one or more GPS satellites. In some embodiments, if the device is moving, the detected location information may include a series of one or more geographical coordinates (e.g., latitudinal-longitudinal coordinates).

At 204, context information associated with the device is obtained. In various embodiments, context information includes sensed data collected from sensors other than the location sensor, data derived from the data sensed by the location sensor, and/or data collected from application(s) at the device. For example, context information may include sensed data collected from non-location sensors such as an accelerometer, a gyroscope, a magnetic sensor, a barometer, a WiFi receiver, and/or a Bluetooth receiver. In another example, context information may include data received from applications at the device, such as, but not limited to: navigation applications, activity (e.g., running or cycling) tracking applications, entertainment (e.g., gaming, media player) applications, productivity applications, and shopping applications. Data received from applications at the device may indicate at least that the applications are currently being executed in the foreground or background at the device. For example, context information such as the type of application that is executing at the foreground may be used to determine a type of activity that the user is engaged in (e.g., whether the user is currently driving, running, or cycling).

In some embodiments, a request for location information associated with the device that is received from an application at the device may cause both steps 202 and 204 to be performed. In some embodiments, steps 202 and 204 may be performed at least partially in parallel.

At 206, matching road information is determined using at least the location information and map data. Identifying information that identifies a road (or a portion thereof) that matches the detected location information is determined using map data. In some embodiments, when relevant map data is available locally at the device, a road, if any, that matches the detected location information that is obtained at step 202 is determined locally at the device. For example, relevant map data includes road information and corresponding GPS coordinate information in the region with which the device is associated. In some embodiments, when relevant map data is not available locally at the device, the relevant map data is requested from a server. After the relevant map data is received from the server, a road that matches the detected location information is determined locally at the device. In some embodiments, when relevant map data is not available locally at the device, the detected location information is sent to the server for the server to determine matching road information.

It is then determined whether the matching road information is consistent with the context information. In the event that the matching road information is consistent with the context information, then the matching road information is determined to be correct. If the matching road information is determined to be correct, then the detected location information is also determined to be correct and therefore, does not need to be corrected.

At 208, the matching road information is determined to be incorrect based at least in part on the context information. However, in the event that the matching road information is inconsistent with the context information, then the matching road information is determined to be incorrect. If the matching road information is determined to be incorrect, then the detected location information is also determined to be incorrect and therefore needs to be corrected.

In some embodiments, to determine whether the matching road information is consistent with the context information, a known attribute associated with the device and/or the user of the device is determined based on the context information. Then, it is determined whether the device can be associated with the matching road information given the known attribute. For example, if the context information that includes barometer data is used to determine a known attribute of the device, which is that the device is at a high elevation/altitude, and the road of the matching road information is associated with a low elevation/altitude, then the matching road information is determined to be incorrect.

At 210, corrected location information is determined based at least in part on the context information and the map data. In some embodiments, where the matching road information is determined to be incorrect, the map data is used to determine one or more candidate correction roads based on the detected location information. In some embodiments, if relevant map data is available locally at the device, then the one or more candidate correction roads can be determined at the device. In some embodiments, if relevant map data is not available locally at the device, then the one or more candidate correction roads can be requested to be determined at a server that stores the map data. For example, it is assumed that while the detected location information is incorrect, the error is small enough that the correct location information is within a predetermined radius/area relative to the detected location information. As such, one or more candidate correction roads are roads in the map data that are determined to be nearby (e.g., within a predetermined distance) based on the detected location information/matching road information. For example, the one or more candidate correction roads are roads that are in the matching road information that the detected location information was not directly on but were rather in the vicinity of the road on which the detected location information directly matched. One of such candidate correction road(s) is selected using the context information. For example, the candidate correction road that is the most consistent with the context information is selected. For example, known attribute(s) associated with the device are derived from the context information and compared to the information of each candidate correction road. The candidate correction road that matches the greatest number of known attributes is selected. The correction location information is then generated based on the selected candidate correction road. For example, the shortest projection between the detected location information and the selected candidate correction road is determined, and the geographical coordinates of the projection onto the selected candidate correction road is determined as the corrected location information. As such, the corrected location information is merged with a selected road in the map data.

At 212, the corrected location information is outputted. The corrected location information is presented at the user interface at the device. In some embodiments, the corrected location information is sent to an application layer application at the device. For example, the corrected location information is sent to the application that had requested the location information of the device. The application may then use the received corrected location information to provide a location-related feature (e.g., a user interface that presents the corrected location information or information derived based on the corrected location information). For example, the recipient application may be a navigation application that presents the current location of the device on a map user interface. In another example, the recipient application may be a navigation application that presents one or more restaurants on a map user interface that deliver to the corrected location information.

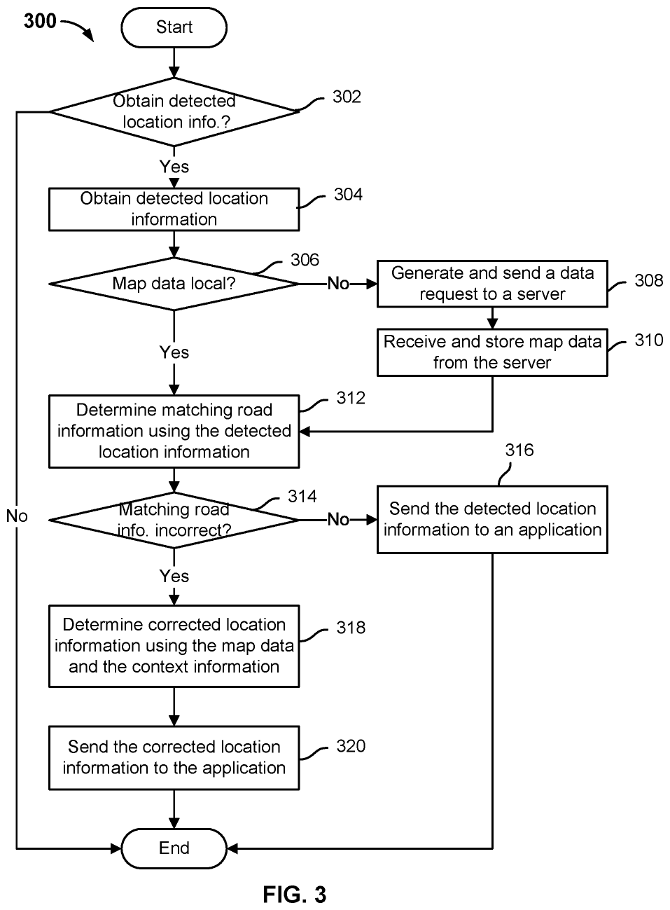

FIG. 3 is a flow diagram showing an example process for correcting location information associated with a device. In some embodiments, process 300 is implemented at system 100 of FIG. 1. Specifically, in some embodiments, process 300 is implemented at device 10 of system 100 of FIG. 1. In some embodiments, process 200 of FIG. 2 may be implemented, at least in part, using process 300.

At 302, whether detected location information is to be obtained is determined. In the event that the detected location information is to be obtained, control is transferred to 304. Otherwise, in the event that the detected location information is not to be obtained, process 300 ends.

Whether the detected location information is to be obtained by a location sensor of the device may be determined when a predetermined condition is met. In some embodiments, the condition is associated with a “user status” of the device. The user status of the device describes the behavior of the user that is using the device. In some embodiments, behavior recognition information associated with the user of the device is collected. For example, behavior recognition information is collected through a sensor hub or an activity recognizing module, and the corresponding user status is recognized. The behavior recognition information is then used to determine a user status. Examples of a user status include, but are not limited to: exercising, driving, walking, consuming entertainment, and sleeping. For example, the exercising status may include running or cycling. As such, one example predetermined condition to trigger the obtaining of the detected location information of the device may be when the user status of the device is one or more of: exercising, driving, and walking. As such, when the predetermined condition is met by the current user status, then the detected location information is collected.

Another example predetermined condition to trigger the obtaining of the detected location information of the device may be when a request for current location information associated with the device is received from an application at the device or from another device.

At 304, detected location information is obtained. The detected location information, which comprises a set of geographical coordinates, for example, is obtained by a location sensor that is local to the device.

At 306, whether map data is locally stored is determined. In the event that map data is locally stored, control is transferred to 312. Otherwise, in the event that the map data is not locally stored, control is transferred to 308. Whether map data that is relevant to the detected location information is stored locally is determined. For example, the current area/region that is associated with the detected location information may be determined and then a map that corresponds to that determined current area/region is locally searched for at the device. For example, if the user of the device's usual location is in the city of Hangzhou, there might be map data stored locally for Hangzhou, but if the user is in the city of Shanghai, then there may be no map data stored locally for Shanghai. The map data includes information associated with each road in a particular area/region. For example, information associated with each road includes the name of the road, the geographical area the road spans, the length of the road, the direction(s) of traffic along the road, the elevation(s) associated with the road, and the type of road (e.g., paved, unpaved, country road, highway).

At 308, a data request is generated and sent to a server. In some embodiments, if the relevant map data is not stored locally, then a data request for the map data is generated and sent to a server that stores the map data. The data request includes the detected location information as a parameter so that the server can retrieve map data that is relevant to the detected location information. In some embodiments, both the current detected location information and historical detected/corrected information may be added to the data request so as to aid the server in determining activity areas. To facilitate processing by the server, network parameters (such as network speed and connected networks, for example) of the device may also be acquired and added to the data request as additional parameters.

At 310, map data is received from the server and stored.

At 312, matching road information is determined using the detected location information. The detected location information is compared to the map data to determine matching road information. In various embodiments, matching road information includes the one or more roads (e.g., an intersection of multiple roads) whose geographical information (e.g., coordinates) matches that of the detected location information. The matching road information may include the name of the road, the longitudinal and latitudinal coordinates of the road, and the length of the road.

In some embodiments, determining matching road information corresponding to the detected location information includes determining whether the detected location information is located on a road on the map data. If the detected location information is located directly on a road, the road where the detected location information is located serves as the matching road information. However, if the detected location information is not located directly on a road, then a road near the detected location information is determined, and the road near the detected location information serves as the matching road information. In some embodiments, comparing the detected location information to the map data includes matching geographical coordinates of the detected location information to a road in accordance with the logic of motion. The logic of motion refers to all kinds of logical information in relation to motion, e.g., type of motion, speed of motion, acceleration, and other such parameters. Moreover, a state of continuous motion may be of assistance in road matching. For example, the user status of the device may serve as a basis for assessing the road. For example, if the user status is in an exercising or walking status, the walking route may be regarded as a road, such as a lane between houses or a track at an athletic field. In another example, if the user status is driving status, then the driving route may be regarded as a road, e.g., a highway. Thus, if the detected location information is located on a road, then the road where the detected location information is located is regarded as the matching road information. If the detected location information is not located on a road, then a road near the detected location information is determined, and the road near the detected location information serves as the road information. The detected location information on a map may be a reference point. For example, the detected location information may be the center of a circle, and a circular area having a set distance as its radius serves as the vicinity of the detected location information. Road names, longitudes and latitudes, and lengths are determined within this circular area, and they serve as the matching road information. Of course, the detected location information may also be the intersection point of diagonal lines of a polygon, and the matching road information is determined within the geographical range surrounding this positioned location. Of course, after it is determined that the detected location information is located on a road, a road near the detected location information may also be acquired as matching road information so as to facilitate subsequent corrections to the detected location information.

In some embodiments, an area of user habitual activity, i.e., a user interaction area, is determined for the user of the device. For example, the area of user habitual activity is defined as an area of activity where the user appears, within a set period of time, more than a set threshold number of times. For example, historical detected and/or corrected location information that has been obtained at the device is used to analyze the areas (e.g., cities, counties, districts) where the user has been. A count is taken of user appearances in each area within a set period of time (e.g., a week or half a month), and areas where the count exceeds a threshold value serve as “areas of user habitual activity.” Thus, it is possible to receive map data corresponding to areas of user habitual activity within a period of time and to use the map data corresponding to the areas of user habitual activity to update stored map data. Map data stored on a device may be periodically updated. When an update period elapses, the stored map data is updated upon a request being made or map data being provided as feedback by a server. Generally, map data for the area of long-term residence is stored locally at the device. For example, a user works and lives in Hangzhou city. Thus, the Hangzhou City map is stored. However, the user may change his or her location due to various reasons such as a business trip, a new job, or travel. Therefore, statistical information on areas where the device has been may be collected over a period of time so as to analyze the user's activity areas within that period. Then, when it is necessary to update the map data, the server acquires map data corresponding to the area of user habitual activity and provides it as feedback. The device receives the map data corresponding to the area of user habitual activity and may use the map data corresponding to the area of user habitual activity to update the stored map data. For example, the map data for a newly added area may be stored while retaining previously stored map data. Or, for example, the newly added map data may replace previously stored map data.

While in the example of process 300, after the device sends the data request to the server at step 308, the device receives map data from the server at step 310, in other examples, the server may use the detected location information that is included in the data request to determine the matching road information and then send back the matching road information alone or in combination with relevant map data to the device. Where the server sends the matching road information back to the device, step 312 no longer needs to be performed at the device.

At 314, whether matching road information is incorrect is determined. In the event that the matching road information is incorrect, control is transferred to 318. Otherwise, in the event that the matching road information is not incorrect, control is transferred to 316. Before the detected location information is corrected, it is first determined whether the matching road information is incorrect. As mentioned above, only if the matching road information is determined to be incorrect based on the context information is the detected location information assumed to also be incorrect and therefore, should be corrected.

In some embodiments, if a road within the matching road information that directly matches the detected location information (e.g., the geographical coordinates of the detected location information match the geographical coordinates of the road) is consistent with the context information, then the matching road information is determined to be correct. In some embodiments, if the road within the matching road information that directly matches the detected location information is inconsistent with the context information, then the matching road information is determined to be incorrect. In some embodiments, to determine whether the matching road information is consistent with the context information, a known attribute associated with the device and/or the user of the device is determined based on the context information. Then, it is determined whether the device can be associated with the matching road information given the known attribute.

In some embodiments, the context information of one or more of direction, speed, and motion status can be derived from the geographical coordinates that have been sensed by the location sensor. For example, the context information may indicate the known attribute that the device is in a high-speed motion status of a moving vehicle and that the motion direction is driving southward. However, if the directly matched road is oriented east-west, and the position along the directly matched road is not at the junction/intersection of the matched road with another road, then it is determined that the matching road information is incorrect. This is because the moving vehicle that the device is in cannot drive south on an east-west road without a branch road. As will be described below, the detected location information will be corrected using one or more roads in the map data that are in the vicinity of the directly matched road.

At 316, the detected location information is sent to an application. If the matching road information is not determined to be incorrect, then the detected location information is also determined to be correct. Therefore, the detected location information can be sent to an application that has requested/is requesting the device's current location. For example, the application is configured to provide a location-based feature using the location information.

At 318, corrected location information is determined using the map data and the context information.

In some embodiments, whether or not a directly matched road is accurate may be determined by road-matching within a preset time given the velocity of the device (or rather, the vehicle on which the device is located) and other such information. Thus, the exact road and position on the road may be determined. Then the detected location information is corrected using the longitude and latitude of the position on the road.

In various embodiments, one or more candidate correction roads are roads in the map data that are determined to be nearby (e.g., within a predetermined distance) based on the detected location information/matching road information. For example, the one or more candidate correction roads are roads that are in the matching road information that the detected location information was not directly on but were rather in the vicinity of the road on which the detected location information directly matched. One of such candidate correction road(s) is selected using the context information. For example, the candidate correction road that is the most consistent with the context information is selected. For example, known attribute(s) associated with the device are derived from the context information and compared to the information of each candidate correction road. The candidate correction road that matches the greatest number of known attributes is selected. In a first example, a known attribute of the device is whether the user of the device is driving or walking and a candidate correction road can then be selected based on whether they are more suitable for driving or walking. In a second example, a known attribute of the device is the direction the device is headed towards and a candidate correction road can then be selected based on the direction of traffic that the road permits. The correction location information is then generated based on the selected candidate correction road. For example, the shortest projection between the detected location information and the selected candidate correction road is determined, and the geographical coordinates of the projection onto the selected candidate correction road is determined as the corrected location information. As such, the corrected location information is merged with a selected road in the map data.

The following are three examples of determining that the matching road information is incorrect and accordingly, generating corrected location information:

A. The motion direction according to the device's location data that led to the detected location information is determined and the direction information of the directly matched road of the matching road information is also determined. The correction location information is then generated using the motion direction of the device. That is, the motion direction of a device is analyzed according to at least the detected location information, and it is determined that the motion direction of the device is a direction such as north, south, west, or east, for example. In addition, the direction information of the directly matched road is determined. Then the motion direction and the direction information serve as a basis to determine whether the user may be driving or walking on this road (e.g., because a person may sometimes walk in the opposite direction of vehicle traffic on a road). Moreover, if the updated position where the device is located along the road (assuming that the detected location information was collected some time ago and the device is still moving along the road) using the speed of the device and then geographical shape/coordinates of the road is determined, then the corrected location information is determined to be the geographical coordinates (e.g., longitude and latitude coordinates) of this updated road position.

B. The motion status and speed of the device according to the device's location data that led to the detected location information is determined. Furthermore, the congestion information of the matching road information is determined by querying a third party traffic service. For example, if the road of the matching road information is congested, but the determined speed of the device is relatively high (the device is associated with a high-speed driving status), then it is determined that the matching road information is incorrect. The map data may be used to determine one or more nearby (candidate correction) roads to the road that had directly matched the detected location information and a candidate correction road is selected. Then the corrected location information is determined based at least in part on the geographical coordinates of the selected candidate correction road.

C. The motion status of the device according to the device's location data that led to the detected location information is determined. Furthermore, the road type of the directly matched road of the matching road information is determined. The motion status of the device, e.g., whether the user of the device is driving or walking/running, may be determined based on which application is executing at the device. For example, if an activity application is executing at the device, then it is inferred that the motion status of the device is walking or running. The road type of the directly matched road of the matching road information may be determined from the map data. For example, if the device corresponds to walking status, yet the road is an elevated highway, then it is determined that the matching road information is incorrect. Or if the device corresponds to any motion status, and the road type of the directly matched road is a highway, then the matching road information is basically accurate but it is still possible to correct the road information with the assistance of direction and other information.

At 320, the corrected location information is sent to the application.

The application to which the corrected location information is sent may be an application that had requested location information of the device or be any application executing at the device for which the user had permitted to receive the user's location information. For example, after the corrected location information is obtained, whenever an application of the application layer requests the location information (e.g., within an expiration period), the corrected location information may be sent to the application layer application to cause the application to provide a positioning-related feature, such as navigation or route querying, for example.

The following is an example of generating corrected location information for a mobile phone positioning and navigation. A map module and a positioning module are located in the system layer of the phone. The positioning module performs fusion positioning by receiving detected location information and context information from one or more of various positioning sensors, such as a GNSS, an accelerometer, a gyroscope, a magnetic sensor, a barometer, WiFi, and Bluetooth, for example. The positioning module may also receive output from a sensor hub or a behavior recognition module at the same time in order to determine whether the device is in a driving mode (i.e., driving status). If it is, the positioning module begins correcting the detected location information using the context information and map data. Correcting detected location information improves the accuracy of the originally detected location data but may also use up to a certain amount of computing and network resources (e.g., cellular data resources). Therefore, the decision on whether to start using the location information correction may be based on user settings.

After detected location information correction begins, the positioning module may transmit the detected location information to the map module. The map module determines whether map data is available locally to perform correction. If not, the map module sends a data request to a server. The server may perform matching between the received detected location information with map data and/or packages map data for the user's current area and sends the data to the map module. If the data that the map module receives back from the server is map data, it stores the data locally and then performs the correction of the detected location information. After the map module obtains matching road information in a manner described above, it sends the matching results back to the positioning module. After the positioning module receives road matching road information, it corrects the detected location information. Lastly, the positioning module outputs the corrected location information to a higher-layer application such as a navigation application.

In some embodiments, the corrected location information may also be sent, as needed, to another terminal device. For example, after a relationship between a mobile phone and a personal computer (PC) is stored, the corrected location information of the phone may be sent to the PC, and the PC may use the corrected location information to provide corresponding positioning services, e.g., querying navigation routes, determining nearby stores, etc.

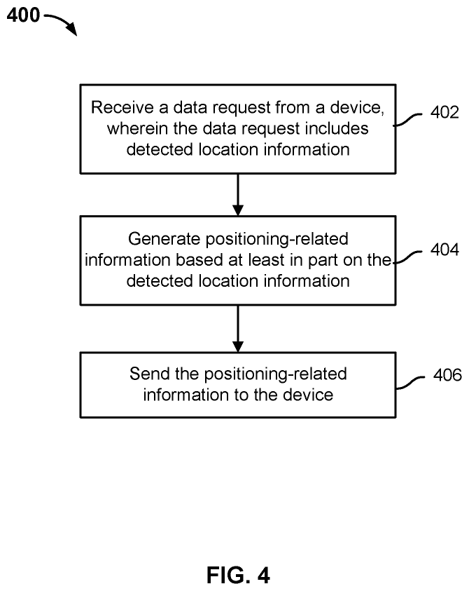

As described above, matching road information to detected location information may or may not be done with the assistance of the server. When the server is needed to determine the matching road information, a process such as process 400 of FIG. 4 may be used.

FIG. 4 is a flow diagram showing an example of a process for responding to a data request. In some embodiments, process 400 is implemented at system 100 of FIG. 1. Specifically, in some embodiments, process 400 is implemented at server 20 of system 100 of FIG. 1.

At 402, a data request is received from a device, wherein the data request includes detected location information.

At 404, positioning-related information corresponding to the detected location information is generated.

At 406, the positioning-related information is sent to the device.

The server may receive a data request from a device. The data request includes detected location information. The detected location information is extracted from the data request and used to obtain positioning-related information. The positioning-related information includes matching road information to the detected location information and/or map data that includes the detected location information. The map data can be used by the device to locally determine matching road information. The server may use the map data to directly determine matching road information that matches the detected location information. The server may acquire map data that is relevant to the area corresponding to the detected location information if the server does not already store the map data.

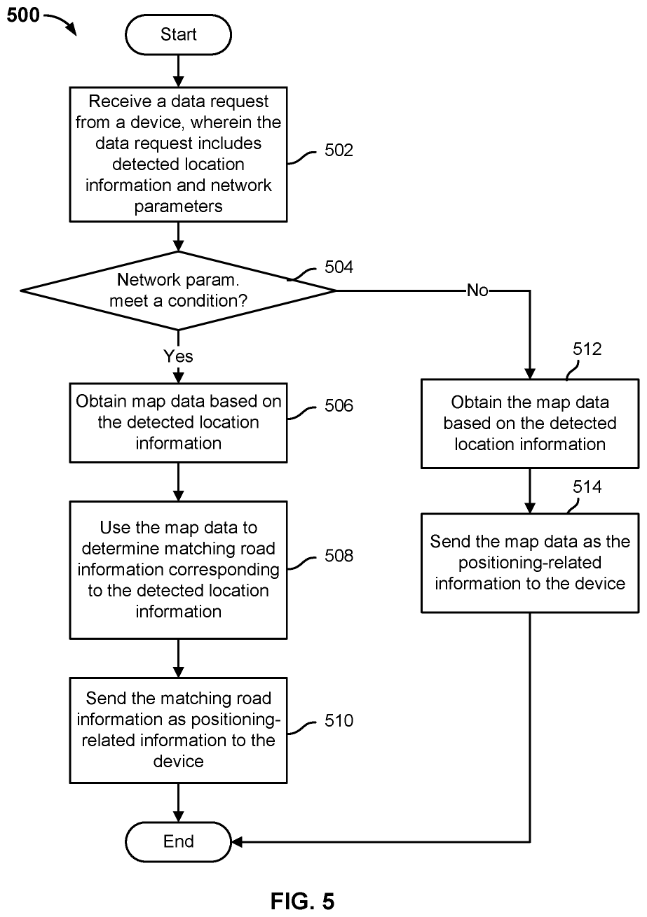

In some embodiments, whether the positioning-related information that is provided as feedback by the server in response to a data request from a device includes one or both of matching road information to the detected location information and/or map data that includes the detected location information is determined using a process such as process 500 of FIG. 5.

FIG. 5 is a flow diagram showing another example process for responding to a data request. In some embodiments, process 500 is implemented at system 100 of FIG. 1. Specifically, in some embodiments, process 500 is implemented at server 20 of system 100 of FIG. 1. In some embodiments, process 400 of FIG. 4 is implemented, at least in part, using process 500.

Process 500 describes an example process where the server flexibly determines to send either the matching road information based on detected location information or the map data that can be used to determine the matching road information at the device based on network parameters associated with the device. If the network speed, among other network parameters, is high enough, then the server will send the matching road information, because it is expected that the device will be able to quickly receive the needed matching road information. However, if the network speed, among other network parameters, is not high enough, then the server will send the map data, because it is expected that the device will have trouble quickly sending/receiving additional data requests for matching road information due to the poorer network conditions. As such, process 500 illustrates how a server can flexibly assist a device in performing the correction of detected location information.

At 502, a data request is received from a device, wherein the data request includes detected location information and network parameters. In addition to the detected location information that is generated at the device, the data request from the device may also include current network parameters associated with the device. For example, the network parameters may include the type of network (e.g., cellular or WiFi) that the device is using to send and receive data and also the current network speed.

At 504, whether the network parameters meet a predetermined network condition is determined. In the event that the predetermined network condition is met, control is transferred to 506. Otherwise, in the event that the predetermined network condition is not met, control is transferred to 512.

For example, the predetermined network condition against which the network parameters that are included in the data request is to be compared comprises a network speed threshold and/or a network type. For example, determining whether the network parameters that are included in the data request meet the predetermined network condition may include one or more of the following example determinations:

Whether the network parameter of network speed exceeds a speed threshold value predetermined network condition. A speed threshold value may be set in advance, e.g., according to user requirements. Then a determination is made as to whether the network speed at least meets the speed threshold value. If the network speed at least meets the speed threshold value, then the positioning condition is met; otherwise, it is not met.

Whether the network parameter of network type is WiFi. The network to which the terminal is connected may be detected based on the network parameters, and the connected network may be assessed as to whether it is a WiFi network. If it is, then the positioning condition is met. If not, then in some examples, the positioning condition is not met, or in some other examples, further detection of the connected network type may be conducted. If analysis indicates that the device is not connected to WiFi, but rather to a mobile communication network, then the assessment may be made based on the specific mobile communication network type, which is described below.

Whether the network parameter of mobile communication network type is lower than third-generation mobile communication network. If the terminal is connected to a mobile communication network, then the type of mobile communication network may be analyzed and an assessment made as to whether it is lower than the third-generation mobile communication network (3G), wherein a mobile communication network type that is not lower than third-generation mobile communication network means a mobile communication network that is 3G, 4G, or higher. If the mobile communication network type is not lower than 3G, then the positioning condition is met; otherwise, the positioning condition is not met.

At 506, map data based is obtained based on the detected location information. For example, the detected location information can be used to determine an area/region (e.g., city) in which the device is currently located. Then, the map corresponding to the determined area/region is obtained.

At 508, the map data is used to determine matching road information corresponding to the detected location information.

In some embodiments, matching the positioning information and the map data to determine corresponding matching road information comprises comparing the geographical coordinates of the detected location information of the data request to the geographical coordinates in the map data. Whether the matching geographical coordinates in the map data are associated with a particular road is determined. Information associated with the directly matching road, if any, is included in the matching road information. If the detected location information does not directly match a road, then information of a nearby road to the geographical coordinates of the detected location information is included in the matching road information.

In some embodiments, it is possible for the server to conduct online matching of road information to the detected location information under relatively good terminal network conditions and could therefore efficiently help determine matching road information for the device. In actual processing, road information matching may be requested periodically, e.g., once every 2 seconds, under relatively good network conditions.

At 510, the matching road information is sent as positioning-related information to the device. Where the predetermined network condition is met, the matching road information is returned as the positioning-related information to the device that had sent the data request.

At 512, the map data is obtained based on the detected location information. For example, the detected location information can be used to determine an area/region (e.g., city) in which the device is currently located. Then, the map corresponding to the determined area/region is obtained. The following is one example of obtaining the relevant map data to detected location information:

The detected location information is used as a reference point and the relevant map data that is obtained is determined using a preset distance from the reference point. For example, there could be multiple preset distances and one such preset distance may be selected based on factors such as a network condition, a data size of the map data, and/or processing speed of the device.

The server may monitor data requests. After receiving a data request, it may judge the current device's network status to assist with subsequent mode selection. If the user's network status is good, then the server will continue to determine and send matching road information back to the device in response to subsequent data requests from the device. Thus, under good network conditions, the server can ensure matching road information determinations while also conserving traffic. After completing road information matching, the server sends the matched result to the device. The device may perform follow-up road information matching to help improve positioning accuracy. If the network status of the device's network is poor, then the server may select a one-time transmission of map data using an offline map of an area near the device so that the device can use map data to conduct continuous road information matching. A combination of the two approaches can achieve improved map-assisted location information correction under various network-related conditions.

In some embodiments, an activity area corresponding to the device within a period of time is determined based on the frequency of the device's presence in an area. Map data corresponding to the activity area can be determined by the server and sent to the device for the device to use to update its locally stored map data, if any. The server periodically sends updated versions of map data that the server had previously sent to the device. Therefore, it is possible to retain a device's location information within a period of time and to report the location information and other such information and thus to analyze the activity area corresponding to the device within that period of time. The activity area may be an administrative area such as a province, city, county, or district. Or the activity area may be determined according to a travel route corresponding to the device. After the activity area is determined, map data corresponding to the activity area may be acquired. Then the map data corresponding to the activity area is sent to the corresponding device to update the map data stored in the device. That is, after each device sends a data request, the server updates the user's behavior information according to the user's position. In other words, it updates the recent activity area and, according to the activity area, periodically (e.g., weekly) determines the offline map data for the activity area and actively pushes it to the device. The server thus sends the map data to the local device where there is a WiFi or other connection for subsequent offline road information matching use.

At 514, the map data is sent as the positioning-related information to the device. Where the predetermined network condition is met, the map data is returned as the positioning-related information to the device that had sent the data request.

An example application of correcting location information is in the context of a navigation application executing on a mobile phone, while the user of the phone is driving. Although many vehicles come with built-in navigation positioning systems, mobile phones are, on account of their user friendliness, still frequently used for navigation. Moreover, mobile phone applications typically have prompter and richer information updates than their vehicle-mounted counterparts. Furthermore, users are sometimes more comfortable with accessing navigation on their phones as compared with vehicle-mounted navigation positioning systems. Therefore, many users use their mobile phones for navigation and positioning when driving. During the navigation process, basic positioning capability, i.e., positioning accuracy, is affected by obstacles such as buildings and roads, and the satellite signals are consequently subject to interference. The consequence of such interference is potential positional drift that may introduce errors in the positioning signals that are received by the phone. Therefore, in some embodiments, map-matching technology is configured in the system layer of a device (e.g., mobile phone) and the map-matching is further enhanced by positioning capabilities. That is, in some embodiments, map-matching is used to assist in the correction of detected location information, and the corrected location information is used as system layer positioning output, which may be called by the navigation application to therefore improve the user's navigation experience. For example, the navigation application may present visualizations on a map user interface based on the received corrected location information.

To continue the example application of correcting location information in the context of a navigation application executing on a mobile phone, the status of the mobile phone is checked for whether the user of the phone is driving. After it is determined that the user is driving, the detected location information of the phone is obtained by the positioning module and then sent to the map module. Then the map module queries whether there is map data available locally for map-matching. If there is, the map module may perform matching based on the local map and return the matched results to the positioning module, which then corrects the detected location information to improve positioning accuracy. If there is no map data available locally, the map module sends a data request to a server. When making the data request, the map module may also send recent, historical detected location information that had been generated at the phone to the server for online map-matching. In view of issues such as network traffic consumption and processing efficiency, the information returned by the server may take multiple optional forms. For example, one approach may be to have the server return matching road information to the user. That is, continuous online matching may be executed by the server (e.g., in response to a series of data requests from the phone). In such an approach, each data request and data return contains matching road information corresponding to the phone's detected location information. This approach provides real-time performance but does not use up much data traffic. To give another example, another approach may be to have the server send data on roads near the user's current area together with other information to the user, in which case map-matching based on an offline map may be conducted immediately by the phone following a request. With such an approach, it is possible for the phone to acquire map data for a portion of an area through a single data request. This approach facilitates matching by the device itself. In actual processing, the more suitable of the two approaches above may be selected according to the current network status of the device. For example, when the device's network is running relatively smoothly, the online mode may be selected to reduce data traffic and offload processing from the device. When the user network has longer response delays, the map data download approach may be selected to ensure that continuous map-matching can be locally performed at the device. In addition, the server may also establish user behavior information based on positioning data such as detected location information that is reported by the user. The behavior information can show a user's activity area within a period of time. The server may periodically send map data associated with the user activity area when the user is connected to WiFi.

In some embodiments, map-matching technology is embedded in the system layer to fundamentally improve the mobile phone's basic positioning capability. Therefore, it is possible to locally cache some offline map data. This portion of offline map data may undergo personalized dynamic updating in accordance with the behavior information established by the server so as to ensure the continual availability of offline map-matching as much as possible. In addition, after the user exits the area that can be covered by the local offline data, a different matching strategy may be selected depending on the network status in order to achieve a balance between performance and traffic. The map-matching results obtained through combined online/offline map-matching are then sent back to the positioning module of the phone to improve positioning accuracy.

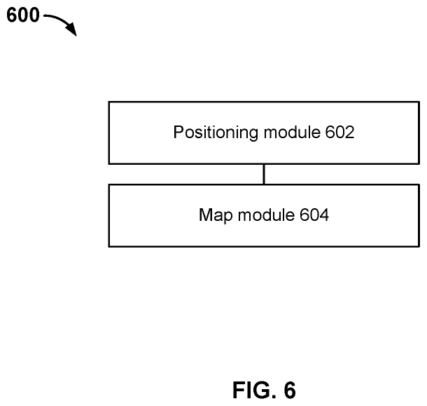

FIG. 6 is a diagram showing an embodiment of a diagram of a device-side positioning system. In some embodiments, positioning system 600 includes positioning module 602 and map module 604. In some embodiments, positioning system 600 is a part of a device.

The modules, sub-modules, and units described herein can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules, sub-modules, and units may be implemented on a single device or distributed across multiple devices.

Positioning module 602 is configured to obtain detected location information using a location sensor. Positioning module 602 is configured to obtain context information using sensors, historical sensed data, and/or data received from applications at the device. Positioning module 602 is also configured to correct the detected location information to obtain corrected location information, if appropriate.

Map module 604 is configured to determine matching road information according to the detected location information using map data.

Map module 604 is configured to obtain map data and to determine corresponding matching road information by matching the detected location information against map data.

In some embodiments, map module 604 is configured to receive matching road information provided as feedback by a server, where the server had already used the map data to determine matching road information corresponding to the detected location information. For example, the matching road information may include: the road that the detected location information directly matches and/or roads near the detected location information.

In some embodiments, map module 604 is configured to obtain locally stored map data and/or receive map data sent back from the network.

Positioning module 602 is configured to correct the detected location information using the context information and the map data.

In some embodiments, positioning module 602 is configured to analyze the direction of motion of the device according to the sensed location information and also obtain the direction information of the road to which the detected location information directly matched. Positioning module 602 is then configured to determine the corrected location information according to the direction information of the device and the direction information of the road. In some embodiments, positioning module 602 is configured to analyze the direction of motion of the device and also to determine congestion information for the road to which the detected location information directly matched. Positioning module 602 is then configured to determine the corrected location information according to the motion status and road type according to the direction information of the device and the congestion information. In some embodiments, positioning module 602 is configured to analyze the motion status according to the detected location information and to determine the road type of the road to which the detected location information directly matched. Positioning module 602 is then configured to determine the corrected location information according to the motion status and road type.

Positioning module 602 is configured to generate corrected positioning information according to latitude and longitude information corresponding to a selected candidate correction road that is nearby (e.g., within a predetermined range) the road to which the detected location information had directly matched.

In some embodiments, positioning module 602 includes a positioning sensor that includes at least one or more of the following: a Global Navigation Satellite System sensor, an accelerometer, a gyroscope, a magnetic sensor, a barometer, a WiFi receiver, and a Bluetooth receiver.

Positioning module 602 is configured to send the corrected positioning information to an application to cause the application to provide a positioning-related feature.

In some embodiments, map module 604 is further configured to generate a data request according to the detected location information and to send the data request to a server to request the server to send back positioning-related information. The positioning-related information comprises: map data for the area corresponding to the detected location information and/or matching road information.

In some embodiments, map module 604 is configured to receive map data corresponding to an activity area of the user of the device within a period of time and use the map data corresponding to the activity area to update stored map data, wherein the activity area is an area in which the number of user appearances exceeds a threshold value within a set period of time.

In some embodiments, positioning module 602 is configured to determine a user status associated with the device. After the user status meets a predetermined condition, positioning module 602 is configured to obtain detected location information according to the positioning sensor. Example user statuses that meet a set condition at least include: exercising status, driving status, and walking status.

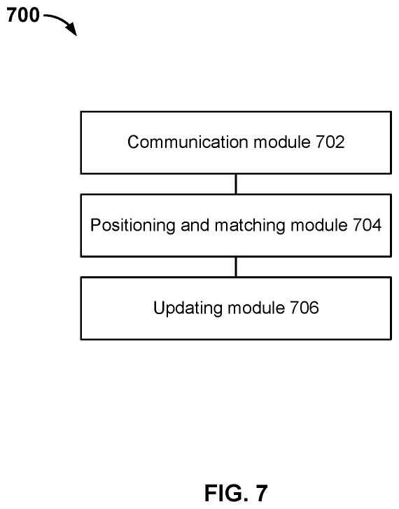

FIG. 7 is a diagram showing an embodiment of a diagram of a server-side positioning system. In some embodiments, positioning system 700 includes communication module 702, positioning and matching module 704, and updating module 706. In some embodiments, positioning system 700 is a part of a server.

Communication module 702 is configured to receive a data request from a device. In some embodiments, the data request includes at least detected location information. In response to the data request, communication module 702 is configured to provide positioning-related information as feedback to enable the device to correct the detected location information.

Positioning and matching module 704 is configured to generate positioning-related information according to the detected location information. The positioning-related information includes: matching road information and/or map data. The map data is to be used by the device to locally perform matching against the detected location information.

Updating module 706 is configured to determine an activity area corresponding to the device within a period of time and obtain map data corresponding to the activity area. The activity area is an area in which the number of user appearances exceeds a threshold value within a set period of time. Updating module 706 is configured to send the map data corresponding to the activity area to the corresponding device to update the map data stored in the device.

In some embodiments, positioning and matching module 704 is configured to obtain map data and determine matching road information by matching the detected location information with the map data.

In some embodiments, positioning and matching module 704 is configured to use the detected location information to determine map data for the area corresponding to the detected location information.

In some embodiments, positioning and matching module 704 is configured to determine whether the detected location information is directly located on a road on the map data. If the detected location information is directly located on a road, that road serves as the matching road information. If the detected location information is not located on a road, then a road near the detected location information is determined, and the road near the detected location information serves as the matching road information.

In some embodiments, positioning and matching module 704 is configured to set the detected location information as a reference point and obtain map data for an area corresponding to a preset distance relative to the reference point.

In some embodiments, positioning and matching module 704 is configured to obtain network parameters of the device corresponding to the data request. When the network parameters meet a predetermined network condition, positioning and matching module 704 is configured to determine matching road information to the detected location information. When the network parameters do not meet a predetermined network condition, positioning and matching module 704 is configured to obtain map data using the detected location information.

In some embodiments, positioning and matching module 704 is configured to determine whether the network parameters meet at least one of the following example predetermined network conditions: whether the network parameter of network speed exceeds a speed threshold value; whether the network parameter of network type is WiFi; whether the network parameter of mobile communication network type is lower than third-generation mobile communication network.

One example application of the various embodiments described herein is with respect to improving the providing of navigation via a mobile phone while the mobile phone is a vehicle. Although vehicles generally come with built-in navigation positioning systems now, mobile phones are, on account of their user friendliness, often better than vehicle-mounted systems. Moreover, mobile phone applications have prompter and richer information updates. Furthermore, users have less trouble operating their phones. Therefore, many users use their mobile phones for navigation and positioning when driving. During the navigation process, basic positioning capability, i.e., positioning accuracy, is affected by obstacles such as buildings and roads, and the satellite signals are consequently subject to interference, resulting in position drift caused by relatively large errors in the positioning signals received by the phone. Therefore, various embodiments described herein use map-matching technology in the system layer and fuse it with positioning capabilities. That is, map-matching is used to assist subsequent correction of location information, and the corrected location information is used as system layer positioning output, which may be called by the navigation application and thus improves the user's navigation experience.

The following is an example application of various embodiments described herein, where the device is a mobile phone. The user status of the mobile phone is checked, and when the phone detects that it is in driving mode, it transfers the detected location information that is obtained by its positioning module to its map module. Then, the map module queries whether there is map data available locally for map-matching. If there is, the map module may perform matching based on the local map and return the matched results to the positioning module, which corrects the detected location information to improve positioning accuracy. If there is no map data available locally, the map module sends a request to a server. When making the request, the map module may also send recent historical detected location information of the device to the server for online map-matching. In view of issues such as traffic consumption and processing efficiency, the information returned by the server may take multiple optional forms. For example, one approach may be to have the server return matching road information to the mobile phone. That is, continuous online matching may be executed. In such an approach, each data request and data return includes matching road information corresponding to the detected location information. This places high requirements on real-time performance and network status but does not use up much data traffic. To give another example, another approach may be to have the server simply send roads near the user's current area together with other information to the user, in which case mapping based on an offline map may be conducted by the device following a request. With such an approach, it is possible to acquire map data for a portion of an area through a single request. This places low requirements on real-time performance and facilitates matching by the device itself. In actual processing, the more suitable of the two approaches above may be selected according to the current network status of the device. For example, when the user network is running relatively smoothly, the online mode may be selected to reduce data traffic. When the user network has longer response delays, the map data download approach may be selected to ensure continuous map-matching and to ensure accuracy. In addition, the server may also establish user behavior information based on detected location information reported by the user. The behavior information can show a user's activity area within a period of time. The server periodically issues map data for the user activity area when the user is connected to WiFi.

Various embodiments embed map-matching technology in the system layer and fundamentally improve the mobile phone's basic positioning capability. Therefore, it is possible to locally cache some offline map data. This portion of offline map data may undergo personalized dynamic updating in accordance with the behavior information established by the server so as to ensure the continual availability of offline map-matching as much as possible. In addition, after the user exits the area that can be covered by the local offline data, a different matching strategy may be selected depending on the network status in order to achieve a balance between performance and traffic. The map-matching results obtained through combined online/offline map-matching are then sent back to the positioning module to improve positioning accuracy at the device.

Various embodiments described herein provide a non-volatile readable storage medium. One or more modules (programs) are stored in the storage medium. When the one or more modules are applied to a device, the device can be enabled to execute instructions of all the method steps.

Various embodiments described herein provide one or more machine-readable media in which are stored instructions, which, when executed by one or more processors, cause a device to execute the positioning methods as described in various embodiments described herein.

Various embodiments described herein provide one or more machine-readable media in which are stored instructions, which, when executed by one or more processors, cause a server to execute the positioning methods as described in various embodiments described herein.

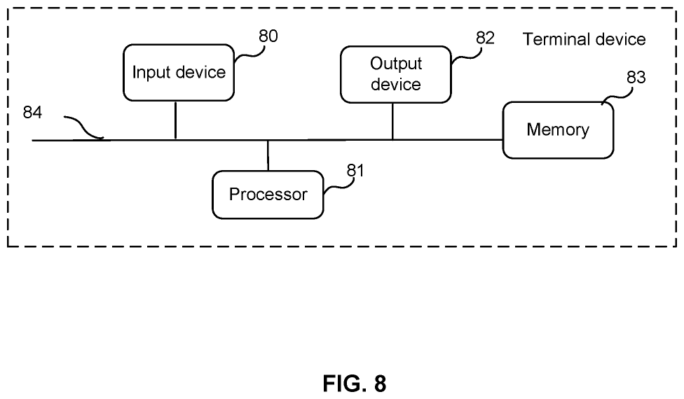

FIG. 8 is a hardware structural diagram of a computing device provided by some embodiments. Computing devices may include servers and devices. As shown in FIG. 8, the computing device may include input device 80, processor 81, output device 82, memory 83, and at least one communication bus 84. Communication bus 84 is configured to implement inter-component communication connections. Memory 83 may include high-speed RAM memory and/or non-volatile memory (NVM), such as at least one magnetic disk storage device. Memory 83 may store various programs used to complete various processing functions and to implement the steps described herein.

Optionally, processor 81 could be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. Processor 81 is coupled to input device 80 and output device 82 through a wired or wireless connection.

Optionally, device 80 may comprise multiple input devices. For example, device 80 could comprise at least one of the following: a user-oriented user interface, a device-oriented device interface, a software programmable interface, a camera, and a sensor. Optionally, the device-oriented device interface may be a wired interface for conducting device-to-device data transmissions, or it could be a hardware insertion interface (e.g., a USB interface or a serial port) for conducting device-to-device data transmissions. Optionally, the user-oriented user interface could, for example, be user-oriented control keys, a speech input device for receiving speech input, or a touchscreen perceiving device (such as a touchscreen or a touch tablet having touch-sensing functions). Optionally, the programmable interface of the software described above could be a portal, such as a chip input pin interface or output interface, through which the user edits or modifies the program. Optionally, device 80 may include a transceiver that could be a radio-frequency transceiver chip, a baseband chip, or a transceiver antenna. A microphone or other audio input device can receive speech data. Output device 82 may include a display device, sound equipment, and other output devices.

In the present embodiment, processor 81 of the computing device comprises functions for executing all modules in the data-processing means in each device. For specific functions and technical results, refer to the embodiments described above. They will not be discussed further here.

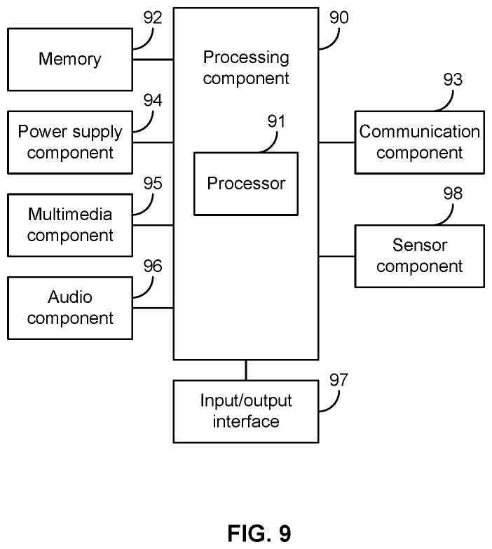

FIG. 9 is a hardware structural diagram of a computing device provided by some embodiments. FIG. 9 is a specific embodiment in the implementation process relating to FIG. 8. As shown in FIG. 9, the computing device of the present embodiment includes processor 91 and memory 92.

Processor 91 is configured to execute the computer program code stored in memory 92 and thus implements the methods of FIGS. 2 through 5 described above.

Memory 92 is configured to store all kinds of data in support of computing device operations. Examples of this data include any application or method instructions, such as messages, pictures, and video, used for operations on the computing device. Memory 92 may include random access memory (RAM) and may also contain non-volatile memory, such as at least one magnetic disk storage device.

Optionally, processor 91 is set up in processing component 90. The computing device may further comprise: communication component 93, power supply component 94, multimedia component 95, audio component 96, input/output interface 97, and/or sensor component 98. The components specifically contained within the computing device are set according to need. The present embodiment imposes no limitations with regard to them.

Processing component 90 generally controls the overall operations of the computing device. Processing component 90 can comprise one or more processors 91 for executing instructions so as to complete all or some of the steps of the method described above with regard to FIGS. 2 through 5. In addition, processing component 90 may comprise one or more modules to facilitate interaction between processing component 90 and other components. For example, processing component 90 may comprise a multimedia module to facilitate interaction between multimedia component 95 and processing component 90.

Power supply component 94 provides electric power to the various components of the computing device. Power supply 94 can include a power supply management system, one or more power supplies, and other components related to generating, managing, and allocating power to the computing device.

Multimedia component 95 includes an output interface display screen provided between the computing device and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touch, sliding actions, and gestures on the touch panel. The touch sensor can not only detect the boundaries of touch or slide actions, but also measure the duration and pressure related to the touch or slide operations.

Audio component 96 is configured to output and/or input audio signals. For example, audio component 96 includes a microphone (MIC). When the computing device is in an operating mode, e.g., speech recognition mode, the microphone is configured to receive external audio signals. The received audio signals can be further stored in storage device 92 or sent by communication component 93. In some embodiments, audio component 96 further comprises a speaker for output of audio signals.

Input/output interface 97 is configured to provide an interface between processing component 90 and peripheral interface modules. The peripheral interface modules may be click wheels, buttons, etc, for example. These buttons may include but are not limited to: volume button, start button, and lock button.

Sensor component 98 comprises one or more sensors and is used to provide status evaluations of various aspects of the computing device. For example, sensor component 98 may detect the on/off status of the computing device, the relative position of the component, and the presence or absence of contact between the user and the computing device. Sensor component 98 may include a near sensor that is configured to detect the presence of a nearby object when there is no physical contact, including measurement of distance between the user and the computing device. In some embodiments, sensor component 98 may further comprise a camera. The sensor component includes a positioning sensor. The positioning sensor includes at least one of the following: a Global Navigation Satellite System sensor, an accelerometer, a gyroscope, a magnetic sensor, a barometer, a WiFi receiver, and a Bluetooth receiver.

Communication component 93 is configured to facilitate wired or wireless communication between the computing device and other devices. The computing device may access wireless networks based on a communications standard such as WiFi, 2G, 3G, or combinations thereof. In an embodiment, the computing device may include a SIM card slot. The SIM card slot is for inserting a SIM card, which enables the computing device to register with a GPRS network and establish communication between the Internet and servers.

It is clear from the above that communication component 93, audio component 96, input/output interface 97, and sensor component 98 that relate to the FIG. 9 embodiment may serve as an implementation of the input device in the FIG. 9 embodiment.

An embodiment of the present application further provides a device, comprising: one or more processors and one or more machine-readable media in which are stored instructions, which, when executed by the one or more processors, cause the device to execute the methods as described in one or more embodiments of the present application.

An embodiment of the present application further provides a server, comprising: one or more processors and one or more machine-readable media in which are stored instructions, which, when executed by the one or more processors, cause the server to execute the methods as described in one or more embodiments of the present application.

An embodiment of the present application further provides an operating system used on a device.

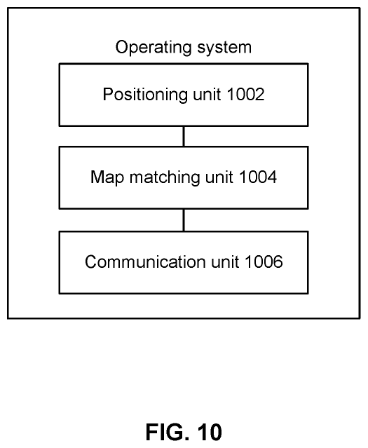

FIG. 10 is a diagram showing an example of a device operating system. As shown in FIG. 10, the device operating system comprises: positioning unit 1002, map matching unit 1004, and communication unit 1006.

Positioning unit 1002 is configured to obtain detected location information according to a location sensor and also obtain context information via one or more sensors and/or applications at the device. Positioning unit 1002 is configured to correct the detected location information using at least map data and the context information.

Map matching unit 1004 is configured to determine matching road information according to the detected location information and the map data.

Communication unit 1006 is configured to send the corrected location information to an application to cause the application to provide a positioning-related feature. In some embodiments, communication unit 1006 is also further configured to send the corrected location information to another device.

Each of the embodiments contained in this specification is described in a progressive manner. The explanation of each embodiment focuses on areas of difference from the other embodiments, and the descriptions thereof may be mutually referenced regarding portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, an embodiment of the present application may take the form of one or more computer program products implemented on computer-usable storage media (including but not limited to magnetic disk memory, CD-ROM, and optical memory) containing computer-usable program code.

In one typical configuration, the computer equipment comprises one or more processors (CPUs), input/output interfaces, network interfaces, and memory. Memory may include such forms as volatile memory in computer-readable media, random access memory (RAM) and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read only memory (CD-ROM), digital versatile disk (DVD) or other optical storage, cassette tapes, magnetic tape and disk storage or other magnetic storage devices, or any other non-transmitting media that may be used to store computer-accessible information. In accordance with the definitions in this document, computer-readable media does not include transitory computer-readable media (transitory media) such as modulated data signals and carrier waves.

The embodiments of the present application are described with reference to flowcharts and/or block diagrams based on methods, devices (systems), and computer program products of the embodiments of the present application. Please note that each process and/or block within the flowcharts and/or block diagrams and combinations of processes and/or blocks within the flowcharts and/or block diagrams can be implemented by computer instructions. These computer program commands can be provided to the processors of general-purpose computers, specialized computers, embedded processor devices, or other programmable data-processing terminals to produce a machine. The commands executed by the processors of the computers or other programmable data-processing terminal devices consequently give rise to means for implementing the functions specified in one or more processes in the flowcharts and/or one or more blocks in the block diagrams.

These computer program commands can also be stored in computer-readable memory that can guide the computers or other programmable data-processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal devices and made to execute a series of steps on the computers or other programmable data-processing terminal devices so as to give rise to computer-implemented processing. The commands executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise the elements.

Detailed introductions were provided above to a positioning method, a positioning means, a device, and a server provided by the present application. This document has applied specific examples to explain the principles and implementations of the present application. The above descriptions of the embodiments are only for the purpose of aiding the understanding of the methods and core concepts of the present application. A person with ordinary skill in the art will always be able to make modifications in keeping with the idea of the present application to specific embodiments and scopes of the application. The content of this specification should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain detected location information associated with the system;
obtain context information associated with the system;
determine matching road information using at least the detected location information and map data;
determine the matching road information to be incorrect based at least in part on the context information;
determine corrected location information based at least in part on the context information and the map data; and
output the corrected location information; and
one or more memories coupled to the one or more processors and configured to provide the one or more processors with instructions.

2. The system of claim 1, wherein the detected location information associated with the system is obtained using at least a location sensor.

3. The system of claim 1, wherein the context information associated with the system includes one or more of the following: data obtained from a non-location-based sensor, data derived from data generated by a location sensor, and data received from an application.

4. The system of claim 1, wherein to determine the matching road information using at least the detected location information and the map data comprises to:
obtain the map data locally; and
compare the detected location information against the map data to determine the matching road information.

5. The system of claim 1, wherein to determine the matching road information using at least the detected location information and the map data comprises to:
determine that the map data is not locally stored;
send a data request to a server, wherein the data request includes the detected location information and network parameters associated with the system; and
receive positioning-related information from the server.

6. The system of claim 5, wherein the one or more processors are configured to:
determine that the positioning-related information comprises the map data; and
compare the detected location information against the map data to determine the matching road information.

7. The system of claim 5, wherein the one or more processors are configured to determine that the positioning-related information comprises the matching road information.

8. The system of claim 5, wherein at the server,
the network parameters were compared to one or more predetermined network conditions; and
in response to a determination that the network parameters met the one or more predetermined network conditions, the positioning-related information is included in the matching road information.

9. The system of claim 5, wherein at the server,
the network parameters were compared to one or more predetermined network conditions; and
in response to a determination that the network parameters did not meet the one or more predetermined network conditions, the positioning-related information is included in the map data.

10. The system of claim 1, wherein to determine the matching road information to be incorrect based at least in part on the context information comprises to:
determine whether the matching road information is consistent with the context information; and
in response to a determination that the matching road information is inconsistent with the context information, determine the matching road information to be incorrect.

11. The system of claim 1, wherein to determine the corrected location information based at least in part on the context information and the map data comprises to:
determine one or more candidate correction roads from the map data based at least in part on the detected location information;
determine a selected candidate correction road from the one or more candidate correction roads based at least in part on the context information; and
determine the corrected location information based on geographical information associated with the selected candidate correction road.

12. The system of claim 1, wherein the one or more processors are further configured to send the corrected location information to an application, wherein the application is configured to provide a location-based feature.

13. A method, comprising:
obtaining detected location information associated with a system;
obtaining context information associated with the system;
determining matching road information using at least the detected location information and map data;
determining the matching road information to be incorrect based at least in part on the context information;
determining corrected location information based at least in part on the context information and the map data; and
outputting the corrected location information.

14. The method of claim 13, wherein determining the matching road information using at least the detected location information and the map data comprises:
obtaining the map data locally; and
comparing the detected location information against the map data to determine the matching road information.

15. The method of claim 13, wherein determining the matching road information using at least the detected location information and the map data comprises:
determining that the map data is not locally stored;
sending a data request to a server, wherein the data request includes the detected location information and network parameters associated with the system; and
receiving positioning-related information from the server.

16. The method of claim 15, further comprising:
determining that the positioning-related information comprises the map data; and
comparing the detected location information against the map data to determine the matching road information.

17. The method of claim 15, further comprising determining that the positioning-related information comprises the matching road information.

18. The method of claim 13, wherein determining the matching road information to be incorrect based at least in part on the context information comprises:
determining whether the matching road information is consistent with the context information; and
in response to a determination that the matching road information is inconsistent with the context information, determining the matching road information to be incorrect.

19. The method of claim 13, wherein determining the corrected location information based at least in part on the context information and the map data comprises:
determining one or more candidate correction roads from the map data based at least in part on the detected location information;
determining a selected candidate correction road from the one or more candidate correction roads based at least in part on the context information; and
determining the corrected location information based on geographical information associated with the selected candidate correction road.

20. A computer program product, the computer program product being embodied in a non-transitory computer readable storage medium and comprising computer instructions for:
obtaining detected location information associated with a system;
obtaining context information associated with the system;
determining matching road information using at least the detected location information and map data;
determining the matching road information to be incorrect based at least in part on the context information;
determining corrected location information based at least in part on the context information and the map data; and
outputting the corrected location information.
